(19) United States
(12) Patent Application Publication
(10) Pub. No.: US 2026/0274236 A1
(43) Pub. Date: Sep. 17, 2026

(54) ACTUATOR ASSEMBLY

(71) Applicant: ZF Active Safety GmbH, Koblenz (DE)

(72) Inventors: Lukas Madzgalla, Lahnstein (DE); Florian Roessinger, Neuwied (DE)

(21) Appl. No.: 19/551,829

(22) Filed: Feb. 27, 2026

(30) Foreign Application Priority Data
Mar. 11, 2025 (DE) 102025109279.6

(51) Int. Cl. B60T 13/74; F16D 55/225; F16D 65/18; F16D 121/24; F16D 125/40; F16D 125/50; F16D 125/56

(52) U.S. Cl. CPC B60T 13/746; F16D 55/225; F16D 65/18; F16D 2121/24; F16D 2125/40; F16D 2125/50; F16D 2125/56

(57) ABSTRACT

An actuator assembly for a vehicle brake has a brake calliper with an intermediate space for a brake rotor. Arranged in the intermediate space is a brake pad. A spindle drive, which has a spindle nut and a spindle is driven by an electric motor for axially moving the spindle nut. The spindle nut is movable by axial displacement between a retracted position and an extended position and in the extended position presses against the brake pad. An electric motor for driving the spindle is coupled to the spindle by way of a gear unit. An output element of the gear unit is coupled to the spindle in a torque-transmitting manner. A joint is formed in the force path between the output element of the gear unit and the spindle nut, by way of which joint the spindle nut can be tilted relative to the output element.

### TECHNICAL FIELD

The invention relates to an actuator assembly for a vehicle brake.

### BACKGROUND

Actuator assemblies in vehicle brakes are used for applying a brake pad to a brake rotor. For this purpose, the actuator assembly usually has a spindle drive, which has a spindle nut and a spindle, driven by an electric motor, for axially moving the spindle nut, wherein an axial feed force for applying the brake pad to the brake rotor is transmitted from the spindle nut to the brake pad.

When the vehicle brake is operated, high lateral forces act on the brake pad and the spindle nut, causing a bending moment in the actuator assembly. Such lateral forces are undesirable, as they lead to loss of performance and efficiency and promote wear of the actuator assembly. The lateral forces that occur change over the life of the actuator assembly due to lining wear, which can lead to inaccuracies in the activation of the vehicle brake or to changes in the braking behaviour.

In known actuator assemblies, a spherical bearing disc is arranged on a contact surface of the spindle directed away from the brake pad. However, owing to the relatively large distance from the brake pad, this does not sufficiently eliminate lateral forces in the actuator assembly.

### SUMMARY

It is therefore an object of the present invention to provide an improved solution for avoiding lateral forces in an actuator assembly of a vehicle brake.

This object is achieved according to the invention by an actuator assembly for a vehicle brake, having a brake calliper in which an intermediate space for a brake rotor is formed, wherein there is arranged in the intermediate space a brake pad, which can be applied to the brake rotor, having a spindle drive, which has a spindle nut and a spindle, driven by an electric motor, for axially moving the spindle nut, wherein the spindle nut is movable by axial displacement between a retracted position and an extended position and in the extended position presses against the brake pad, and having an electric motor for driving the spindle, said electric motor being coupled to the spindle by way of a gear unit. An output element of the gear unit is coupled to the spindle in a torque-transmitting manner, wherein a joint is formed in the force path between the output element of the gear unit and the spindle nut, by way of which joint the spindle nut can be tilted relative to the output element.

By means of the joint, lateral forces and bending moments in the actuator assembly are largely avoided, so that less wear occurs and consequently the life of the actuator assembly is increased. By avoiding lateral forces, axial bearings present in the actuator assembly are also relieved. Losses of force due to friction are also reduced, so that the efficiency of the actuator assembly is optimized.

In a vehicle brake having an actuator assembly according to the invention, a pressure distribution on the brake pad is also particularly uniform, so that, when considered over the surface, uniform wear takes place. In other words, angular wear is avoided.

Starting from a neutral position, the joint allows a tilt of up to 3°, for example.

According to one aspect, the joint comprises a joint head and a receptacle for the joint head, wherein the joint head has two portions that taper in opposite directions. Thus, in its neutral position, the joint head lies against an inner wall of the receptacle only along an interface between the tapered portions. Friction within the joint is thus reduced, so that the joint moves particularly smoothly.

The receptacle has, for example, a square cross section and the joint head has the shape of two truncated pyramids, which are connected to each other at their base. In this way, the angular play is limited to a defined value. This prevents the mechanical components within the actuator assembly from being overloaded.

The truncated pyramid shape allows the joint to pivot in four directions.

At the same time, the truncated pyramid shape allows a torque-transmitting coupling to be realized, so that no additional rotation prevention is required in the joint.

The joint head may be rounded at the transition between the two tapered portions. The rounding allows a more even movement of the joint head in the receptacle. In other words, it is avoided that the joint head tips abruptly only when a load threshold is exceeded.

According to one aspect, the joint is formed between the spindle and the output element. In other words, the joint is arranged at the interface between the gear unit and the spindle drive. The receptacle is formed, for example, in the output element, and the joint head is formed at the spindle end. This effectively avoids lateral forces that occur when the vehicle brake is operated being introduced into the gear unit by way of the spindle drive.

According to an alternative embodiment, the spindle is in two parts and has a spindle shaft and a spindle sleeve, wherein the joint is formed between the spindle shaft and the spindle sleeve. The lateral forces that occur when the vehicle brake is operated are thus compensated for within the spindle drive and thus do not continue to the gear unit.

For example, the spindle sleeve is held axially on the spindle shaft by means of at least one elastic element, wherein the at least one elastic element is fastened to the spindle shaft by means of a fastening means. The elastic element causes the spindle sleeve to be held on the spindle shaft under compressive stress. In addition, the elastic element, unlike a completely rigid fastening means, allows the necessary movability of the spindle sleeve relative to the spindle shaft in order to permit the desired tilting movement of the joint.

According to one aspect, the spindle is supported axially on the brake calliper or on a housing fastened to the brake calliper by way of an axial bearing, wherein there is arranged between the axial bearing and the spindle an intermediate element, which has on its side facing towards the spindle a spherically shaped surface against which the spindle lies. By means of such an intermediate element, a better load distribution of the axially acting force on the axial bearing is achieved.

A mid-point of the spherical surface is located, for example, in the intermediate space for accommodating the brake rotor. Thus, a particularly advantageous curvature of the spherical surface is achieved, in particular such that the intermediate element does not block a tilting of the spindle sleeve relative to the spindle shaft.

The spindle sleeve may be applied against the spherically shaped surface by the at least one elastic element. The elastic element thereby causes a tolerance compensation, so that the spindle sleeve lies against the spherical surface without play.

According to one aspect, the gear unit comprises a planetary gear, and a planet carrier of the planetary gear forms the output element of the gear unit. Because the planet carrier acts directly as the output element, the torque can be transmitted without deviations or losses. This increases the efficiency of the system and minimizes mechanical losses.

For example, the planet carrier has the receptacle. The joint thus also serves to couple the planet carrier to the spindle in a torque-transmitting manner. In this case, it is not necessary to manufacture the spindle in two parts, which simplifies manufacture of the actuator assembly.

The spindle is held axially in the brake calliper by way of a bearing ring, for example.

The spindle may be supported radially by means of a sliding bearing on the brake calliper or on a housing fastened to the brake calliper. By means of the sliding bearing, radial play of the spindle is reduced.

### BRIEF DESCRIPTION OF THE DRAWINGS

Further advantages and features of the invention will become apparent from the following description and from the accompanying drawings, to which reference is made. In the drawings:

FIG. 1 shows a perspective sectional illustration of an actuator assembly according to the invention,

FIG. 2 shows a planet carrier of a gear unit of the actuator assembly from FIG. 1,

FIG. 3 shows a spindle of the actuator assembly from FIG. 1,

FIG. 4 shows a joint that is present between the planet carrier and the spindle,

FIG. 5 shows a spindle tilted in comparison to a neutral position,

FIG. 6 shows schematically a cross section through the joint,

FIG. 7 shows an actuator assembly according to a further embodiment according to the invention,

FIG. 8 shows a spindle shaft of the actuator assembly from FIG. 7,

FIG. 9 shows a spindle sleeve of the actuator assembly from FIG. 7, and

FIG. 10 shows the actuator assembly from FIG. 7 in a state in which the spindle sleeve is pivoted.

### DESCRIPTION

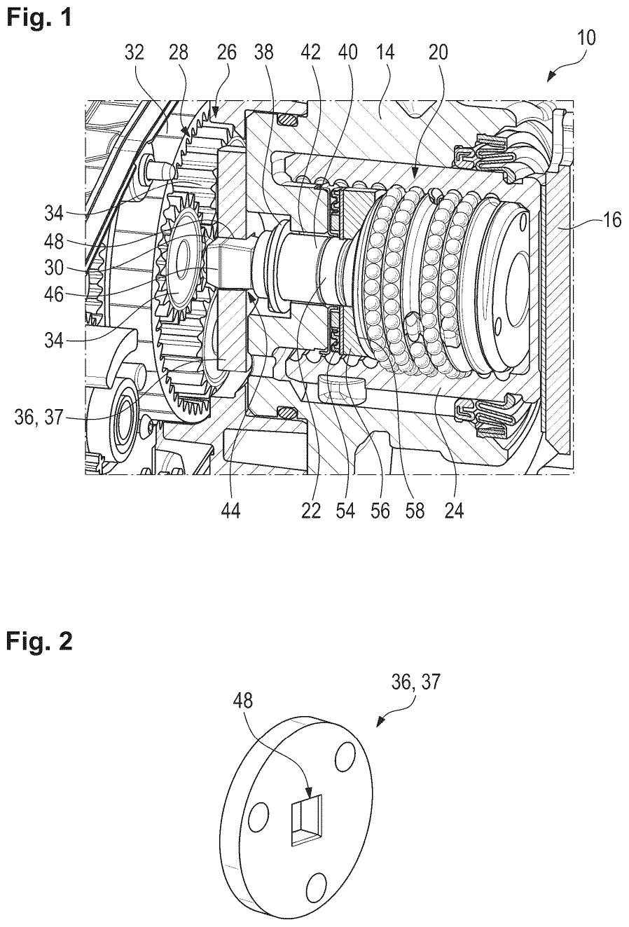

FIG. 1 shows an actuator assembly 10 for an electromechanical vehicle brake.

The actuator assembly 10 comprises a brake calliper 14, in which an intermediate space for a brake rotor is formed. The brake rotor is not visible in the figures.

Brake pads 16 which can be applied to the brake rotor are arranged in the intermediate space.

The actuator assembly 10 comprises a spindle drive 20, which in the exemplary embodiment is a ball screw mechanism, having a rotatably mounted spindle 22 on which is mounted a linearly guided spindle nut 24.

In order to apply the brake pads 16 to the brake rotor, the spindle nut 24 can be moved by axial displacement between a first, retracted position and a second, extended position. In the extended position, the spindle nut 24 presses against the brake pad 16.

In the exemplary embodiment, the spindle nut 24 forms a brake piston, that is to say the spindle nut 24 presses directly against the brake pad 16. However, it is also conceivable that the spindle nut 24 presses indirectly against the brake pad 16 by way of an additional brake piston mounted on the spindle nut 24.

An axial displacement of the spindle nut 24 is caused by a rotation of the spindle 22. For this purpose, the spindle 22 is driven by an electric motor.

An electric motor (not visible in the figures) is coupled to the spindle 22 for driving the spindle 22 by way of a gear unit 26.

The gear unit 26 comprises a planetary gear 28 having a driven sun gear 30, a ring gear 32, a plurality of planet gears 34 and a planet carrier 36.

The planet carrier 36 forms an output element 37 of the gear unit 26 and is coupled to the spindle 22 in a torque-transmitting manner.

The spindle 22 is held axially in the brake calliper 14 by way of a bearing ring 38.

Between the spindle 22 and the brake calliper 14, more precisely between a spindle shaft 40 and the brake calliper 14, there is a radial gap 42, which allows a certain play between the spindle 22 and the brake calliper 14. The need for this radial play will become clearer in the following.

In the actuator assembly 10 illustrated in FIG. 1, a joint 44 is formed in the force path between the output element 37 of the gear unit 26, that is to say the planet carrier 36, and the spindle nut 24, and the spindle nut 24 can be tilted relative to the output element 37 by way of said joint. Specifically, the spindle 22 and together therewith also the spindle nut 24 can be tilted relative to the planet carrier. The radial play between the spindle 22 and the brake calliper 14 gives the spindle 22 the necessary clearance to allow the spindle 22 to tilt.

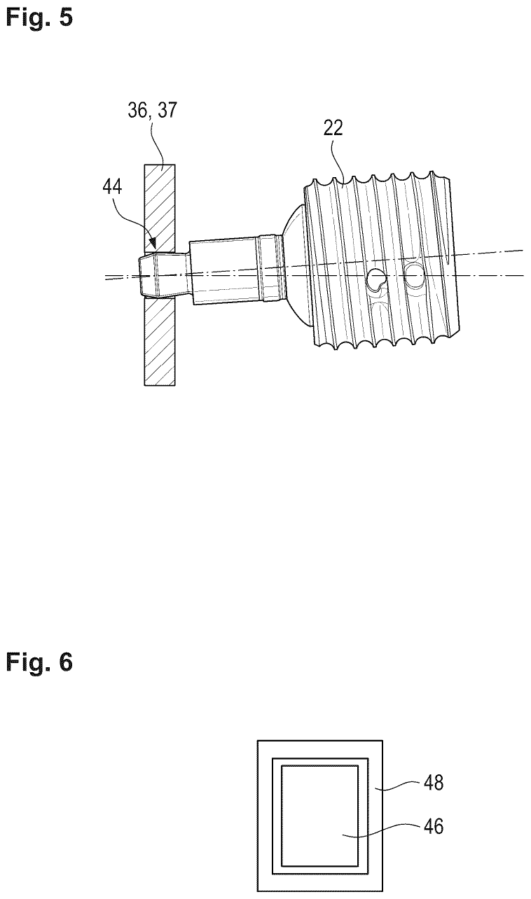

The spindle 22 is shown by way of illustration in FIG. 5 in a state tilted relative to the planet carrier 36.

The joint 44 comprises a joint head 46 and a receptacle 48 for the joint head 46.

In the exemplary embodiment illustrated in FIG. 1, the receptacle 48 is formed in the planet carrier 36, which is shown separately in FIG. 2. The receptacle 48 has a square cross section.

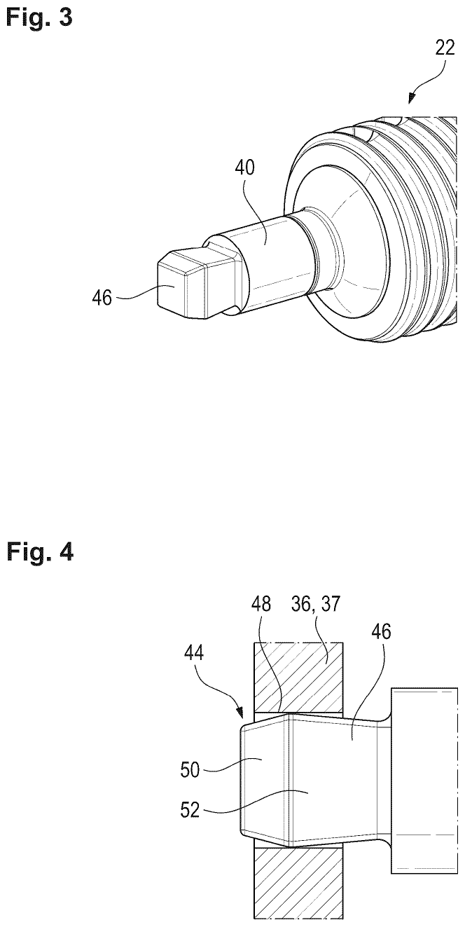

The joint head 46 is formed at an end of the spindle 22 that is directed towards the gear unit 26, as can also be seen in FIG. 3.

In other words, the joint 44 is formed in the exemplary embodiment illustrated in FIG. 1 between the output element 37, or the planet carrier 36, and the spindle 22.

FIG. 4 shows the joint 44 in a detailed view, wherein the planet carrier 36 is shown cut away in order to show the joint head 46.

The joint head 46 has two portions 50, 52 tapering in opposite directions.

More specifically, the joint head 46 has the form of two truncated pyramids, which are connected to each other at their base. Each truncated pyramid forms one of the tapered portions 50, 52.

At the transition between the two tapered portions 50, 52, the joint head 46 is rounded.

Because the joint 44 allows the spindle 22 to tilt relative to the planet carrier 36, lateral forces that can occur on actuation of the actuator assembly 10 can be eliminated.

The side faces of the truncated pyramids form a stop when the spindle 22 tilts, when the spindle 22 is tilted so far that the entire surface of a side face of a truncated pyramid lies against an inner side of the receptacle 48.

Between the joint head 46 and the receptacle 48 there is a certain angular play. This is shown by reference to FIG. 6, which represents a cross section through the joint 44, wherein the planet carrier 36 is not shown in full, only the receptacle 48 being shown.

For example, the angular play is between 1° and 3°. A certain play between the receptacle 48 and the joint head 46 contributes to the fact that the joint head 46 moves particularly smoothly in the receptacle 48 and can be tilted without great force. Reliable compensation for these lateral forces can thus be ensured even in the case of low lateral forces.

The spindle 22, as shown in FIG. 1, is supported axially on the brake calliper 14 by way of an axial bearing 54, wherein there is arranged between the axial bearing 54 and the spindle 22 an intermediate element 56, which on its side facing towards the spindle 22 has a spherically shaped surface 58 against which the spindle 22 lies. The spindle 22 is consequently supported on the axial bearing 54 by way of the intermediate element 56 in any angular position.

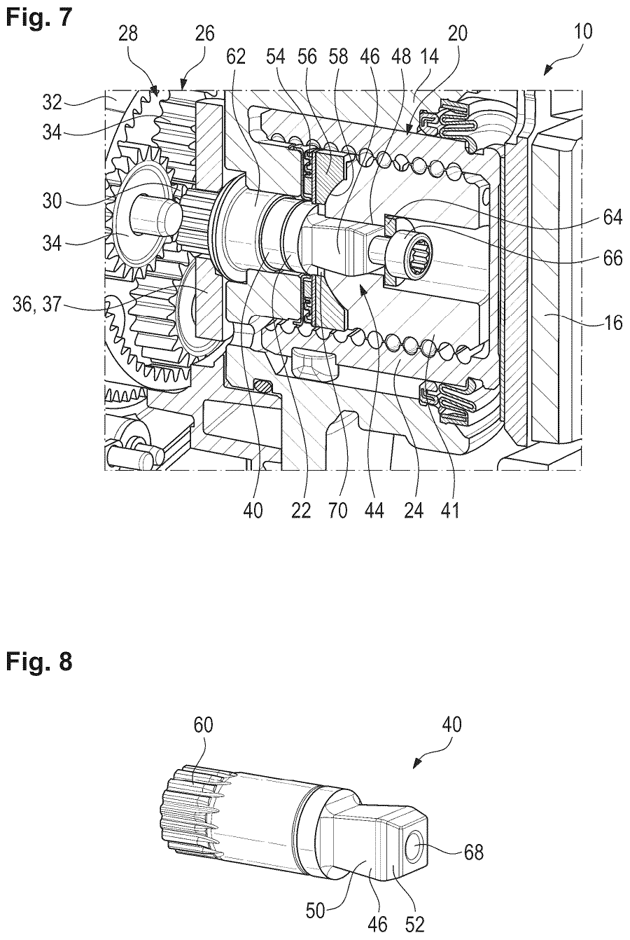

FIGS. 7 to 10 show a further embodiment of an actuator assembly 10.

In the description below, the same reference signs are used for identical structures with the same functions as known from the above embodiment, and to this extent reference is made to the preceding explanations, wherein only the differences between the respective embodiments will be discussed below so as to avoid repetition.

The actuator assembly 10 according to FIGS. 7 to 10 differs from the actuator assembly 10 according to FIGS. 1 to 6 in the arrangement of the joint 44.

The joint 44 is likewise arranged in the force path between the output element 37 of the gear unit 26 and the spindle nut 24.

However, the joint 44 is formed not at the interface between the planet carrier 36 and the spindle 22, but within the spindle 22.

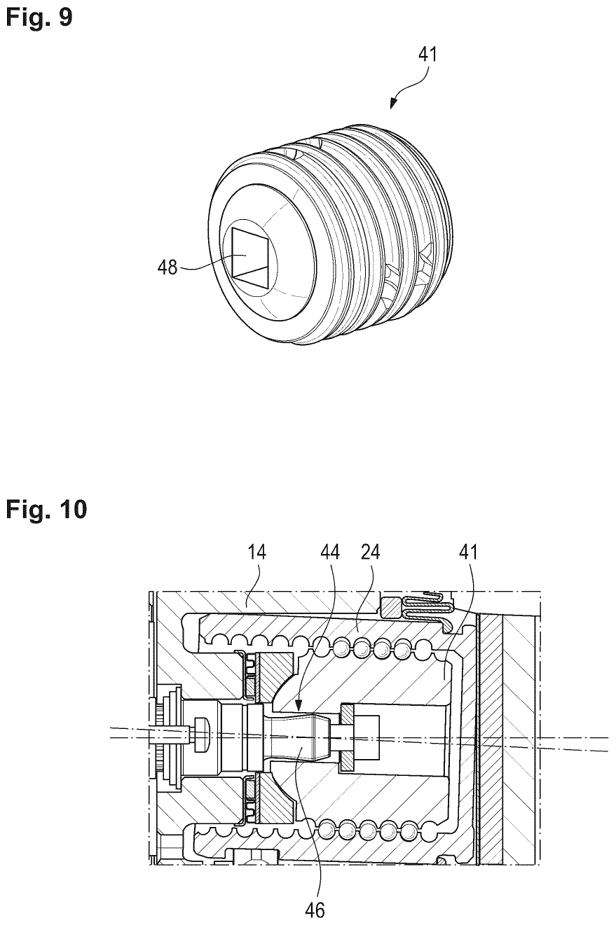

For this purpose, the spindle 22 is configured in two parts and comprises, in addition to the spindle shaft 40 shown in FIG. 8, a spindle sleeve 41, which is formed separately from the spindle shaft 40 and is shown in FIG. 9.

The joint 44 is formed between the spindle shaft 40 and the spindle sleeve 41. The joint head 46 is arranged at an end of the spindle shaft 40 that is accommodated in the spindle sleeve 41, as shown in FIG. 7. The shape of the joint head 46 and of the receptacle 48 corresponds to the shape already described in connection with FIGS. 1 to 6.

In this case, the spindle shaft 40 is coupled to the planet carrier 36 in a torque-transmitting manner by a toothing 60.

Since the spindle shaft 40 does not tilt, no radial play between the spindle shaft 40 and the brake calliper 14 is required in this case. The spindle shaft 40 is instead mounted radially in the brake calliper 14 by means of a sliding bearing 62. However, a certain amount of play of the spindle sleeve 41 is required instead.

The spindle sleeve 41 is held axially on the spindle shaft 40 by means of an elastic element 64. The elastic element 64 is, for example, a Belleville spring or a Belleville spring package. An elastically compressible ring is also conceivable.

The elastic element 64 is fastened to the spindle shaft 40 by means of a fastening means 66. In the exemplary embodiment, the fastening means 66 is a screw. The spindle shaft 40 has a corresponding screw hole 68 (see FIG. 8).

The fastening means 66 can, however, also be swaged or riveted to the spindle shaft 40.

The spindle sleeve 41 is applied by the elastic element 64 against the spherically shaped surface 58.

A further elastic element 70 may be arranged between the spindle sleeve 41 and the spindle shaft, the spindle sleeve 41 additionally being supported on said further elastic element.

In FIG. 10, the spindle sleeve 41 together with the spindle nut 24 is shown in a tilted state.

1. Actuator assembly for a vehicle brake, having
a brake calliper in which an intermediate space for a brake rotor is formed, wherein there is arranged in the intermediate space a brake pad, which can be applied to the brake rotor,
a spindle drive which has a spindle nut and a spindle, driven by an electric motor, for axially moving the spindle nut, wherein the spindle nut is movable by axial displacement between a retracted position and an extended position and in the extended position presses against the brake pad,
an electric motor for driving the spindle, said electric motor being coupled to the spindle by way of a gear unit, wherein an output element of the gear unit is coupled to the spindle in a torque-transmitting manner, and wherein a joint is formed in the force path between the output element of the gear unit and the spindle nut by way of which joint the spindle nut can be tilted relative to the output element.

2. Actuator assembly according to claim 1, wherein the joint comprises a joint head and a receptacle for the joint head, wherein the joint head has two portions that taper in opposite directions.

3. Actuator assembly according to claim 2, wherein the receptacle has a square cross section and the joint head has the shape of two truncated pyramids, which are connected to each other at their base.

4. Actuator assembly according to claim 2, wherein the joint head is rounded at the transition between the two tapered portions.

5. Actuator assembly according to claim 1, wherein the joint is formed between the spindle and the output element.

6. Actuator assembly according to claim 1, wherein the spindle is in two parts and has a spindle shaft and a spindle sleeve wherein the joint is formed between the spindle shaft and the spindle sleeve.

7. Actuator assembly according to claim 6, wherein the spindle sleeve is held axially on the spindle shaft by means of at least one elastic element wherein the at least one elastic element is fastened to the spindle shaft by means of a fastening means.

8. Actuator assembly according to claim 1, wherein the spindle is supported axially on the brake calliper or on a housing fastened to the brake calliper by way of an axial bearing wherein there is arranged between the axial bearing and the spindle an intermediate element, which has on its side facing towards the spindle a spherically shaped surface against which the spindle lies.

9. Actuator assembly according to claim 7, wherein the spindle sleeve is applied against the spherically shaped surface by the at least one elastic element.

10. Actuator assembly according to claim 1, wherein the gear unit comprises a planetary gear, and a planet carrier of the planetary gear forms the output element of the gear unit.

11. Actuator assembly according to claim 2, wherein the planet carrier has the receptacle.
